(19) United States
(12) Patent Application Publication
(10) Pub. No.: US 2010/0153274 A1
(43) Pub. Date: Jun. 17, 2010

(54) METHOD AND APPARATUS FOR MUTUAL AUTHENTICATION USING SMALL PAYMENTS

(75) Inventors: Bjorn Markus Jakobsson, Mountain View, CA (US); Christopher Soghoian, Somerville, MA (US)

Correspondence Address: PVF -- PARC;c/o PARK, VAUGHAN & FLEMING LLP, 2820 FIFTH STREET, DAVIS, CA, 95618-7759, US

(73) Assignee: PALO ALTO RESEARCH CENTER INCORPORATED, Palo Alto, CA (US)

(21) Appl. No.: 12/335,936

(22) Filed: Dec. 16, 2008

(51) Int. Cl. H04L 9/32; G06Q 20/00

(52) U.S. Cl. 705/71; 705/44

(57) ABSTRACT

One embodiment provides a system for mutual authentication. During operation, a first entity receives an access request from a second entity. In response, the first entity requests information about the second entity's account with a financial service provider (FSP) and transfers a fund to the account. The first entity sends first and second messages through the FSP to the second entity with the fund. Subsequently, the first entity receives from the second entity a first input corresponding to the first message and determines that a first condition is met based on the received first input and the first message. The first entity sends a second input to the second entity based on the second message, thereby allowing the second entity to verify that a second condition is met based on the second input and the second message. The system then produces a result indicating that both the first and second entities are mutually authenticated.

### BACKGROUND

1. Field

The present disclosure relates to computer security. More specifically, the present disclosure relates to using small payments for mutual authentication.

2. Related Art

Several existing organizations, especially those providing financial services, authenticate a user or a user's ownership to a bank account using random small payments. For example, to confirm a user's ownership to a registered bank account, PayPal™ sends two small random payments to the account and requires the user to report the amount of those payments. By doing so, PayPal™ effectively outsources the user identity verification to the bank, which typically only allows the owner of the account to access his account and view the transaction history.

However, such an approach has certain drawbacks. The transferred funds, although small, when accumulated could be costly to the organization. As a way to reduce cost, the organization may desire to minimize the amount of payment sent to the user account. For example, instead of sending two random payments ranging from 1 cent to 99 cents, Paypal™ may choose to send two random payments ranging from 1 cent to 10 cents, thus cutting the cost tenfold. As a result, the probability of an adversary managing to falsely claim ownership of a bank account is increased from 1/10,000 to 1/100. In other words, the reduction of costs in this solution leads to loss of “entropy,” which in turn reduces the efficacy of such systems. Once successful, such an adversary can funnel money out of the falsely claimed bank account through PayPal™.

To minimize cost and at the same time reduce the odds of an adversary guessing the transferred amount correctly, some service providers perform a certain number of positive-amount fund transfers and certain number of negative-amount fund transfers. However, although reduced, the probability for an adversary to guess the amount correctly is still relatively high. In addition, this approach increases the complexity of user operation because most banks require a user to authorize any withdrawals from his account.

Thus, there is a lack of cryptographic-strength authentication mechanism. Current random-fund transfer mechanisms are not sufficiently secure, and these mechanisms can become more difficult and/or more expensive to run when parameters are chosen to increase security. Moreover, there is no degree of mutual authentication in these mechanisms. Although the user is authenticated for ownership of the bank account by reporting the amounts of the transactions, the entity that the user reports to is not authenticated. In other words, the user cannot know for sure that he is communicating with the same organization (or an authorized representative) as he communicated with prior to the fund transfers.

### SUMMARY

One embodiment of the present invention provides a system for mutual authentication. During operation, a first entity in the system receives a request for resource access from a second entity. In response, the first entity requests information about the second entity's account with a financial service provider (FSP) and transfers a fund to the second entity's account. The first entity sends a first message and a second message through the FSP to the second entity with the fund transfer. Subsequently, the first entity receives from the second entity a first input corresponding to the first message and determines that a first condition is met based on the received first input and the first message. The first entity sends a second input to the second entity based on the second message, thereby allowing the second entity to verify that a second condition is met based on the second input and the second message. The system then produces a result indicating that both the first and second entities are mutually authenticated.

In a variation on this embodiment, the first and/or the second messages comprise randomly generated alphanumeric strings.

In a variation on this embodiment, the first message comprises an encryption key.

In a further variation, the first input comprises a message encrypted with the encryption key.

In a variation on this embodiment, a proxy for the first entity performs the fund transfer to the second entity's account.

In a variation on this embodiment, the second entity further sends a message to the first entity identifying the amount of the transferred fund.

### BRIEF DESCRIPTION OF THE FIGURES

FIG. 1 illustrates an exemplary computing environment for mutual authentication using small payments in accordance with one embodiment of the present invention.

FIG. 2 illustrates a block diagram for a web server capable of mutual authentication in accordance with one embodiment of the present invention.

FIG. 3 presents a flowchart illustrating the process of mutual authentication using small payments in accordance with one embodiment of the present invention.

FIG. 4 illustrates an exemplary computer system for mutual authentication using small payments in accordance with one embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

Embodiments of the present invention provide a system for mutual authentication between two entities, such as a user and a server. By taking advantage of the authenticity inherent within a user's account with a financial service provider (FSP), embodiments of the present invention can provide cryptographic-strength of mutual authentication. This mutual authentication can then facilitate a number of authentication-based applications, such as access control, password resetting, and secure communication. In one embodiment, a user provides his account information from an FSP to the server. The server then sends two messages along with a small payment to the user's account. In response, the user sends an input back to the server based on the first message to authenticate himself. After authenticating the user based on the first message, the server also sends a response based on the second message to the user. By comparing the server's response with the previously received second message, the user can ensure that the entity with which he is communicating is the same entity that initially sent him the payment with the two messages.

Conventional small-payment-based confirmation systems, such as PayPal™, only relies on the payment amount to authenticate users. Such authentication is relatively insecure, because it would be fairly easy for an adversary to guess the payment amount. Furthermore, such convention techniques can only provide one-way authentication. In other words, a user has no way of knowing whether the server has been compromised and that he is sending confidential information to an imposter. In contrast, by using alphanumeric strings (in addition to payments) and providing two-way challenges, embodiments of the present invention can provide cryptographic-strength mutual authentication with little added costs.

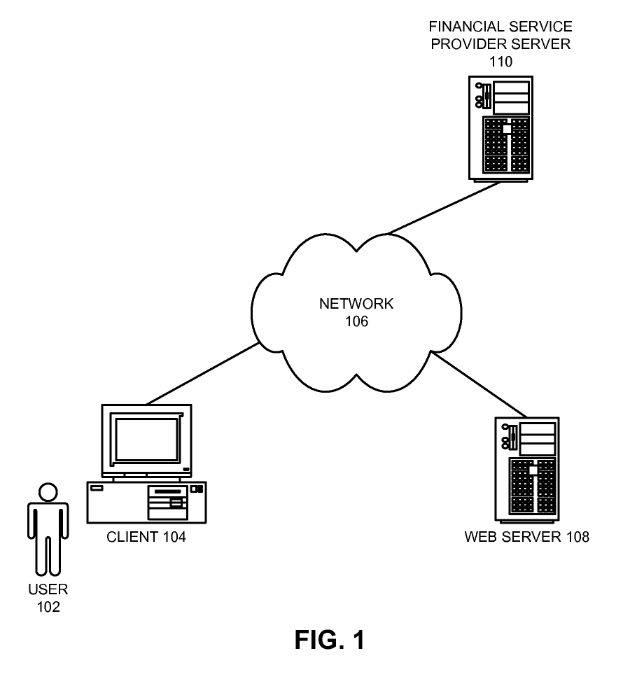

FIG. 1 illustrates an exemplary computing environment for mutual authentication using small payments in accordance with one embodiment of the present invention. In this environment, a user 102 is coupled to a network 106 via a client 104. A a web server 108 provides web services. A financial service provider (FSP) server 110 provides online access to an FSP.

During operation, web server 108 obtains user 102's account information associated with FSP server 110. Web server 108 then transfers a small payment with two messages to user 102's account. In response user 102 sends back an input to web server 108, wherein the input is based on the first message and/or the payment amount. Based on this input, web server 108 authenticates user 102 and sends a response based on the second message to user 102. User 102 then authenticates web server 108 based on the response and the stored second message.

Note that the above communication can be carried out via client 104 and network 106. Furthermore, the computing environment illustrated in FIG. 1 is only one exemplary implementation of the various embodiments of the present invention. For example, User 102 may correspond to: an individual, a group of individuals, an organization, a group of organizations, a computing system; a group of computing systems; or any other entity that can access client 104.

Client 104 may represent nodes on network 106 with computational capability and mechanisms for communicating across the network. For example, client 104 may correspond to personal computers (PCs), laptop computers, workstations, and/or other electronic computing devices with network connectivity. Furthermore, client 104 may connect to network 106 using one or more wired and/or wireless connections.

Web server 108 may correspond to nodes on a network that include functionality to service requests from client 104. For example, web server 108 may provide a peer-to-peer fund transfer service to client 104. Web server 108 may participate in an advanced computing cluster, or can act as stand-alone servers. Note that the entity that authenticates user 102 does not have to be a web server. It can also be an access control server, authentication server, or any entity that can perform user authentication.

FSP server 110 may be any computing system that provides access to a user's account. It can be web based or proprietary.

Network 106 may correspond to any type of wired or wireless communication channels capable of coupling together computing nodes (e.g., client 104, web server 108, and FSP server 110). This includes, but is not limited to, a local area network (LAN), a wide area network (WAN), and/or a combination of networks. In one or more embodiments of the present invention, network 106 includes the Internet. Network 106 may also include phone and cellular phone networks, such as Global Systems for Mobile communications (GSM) networks.

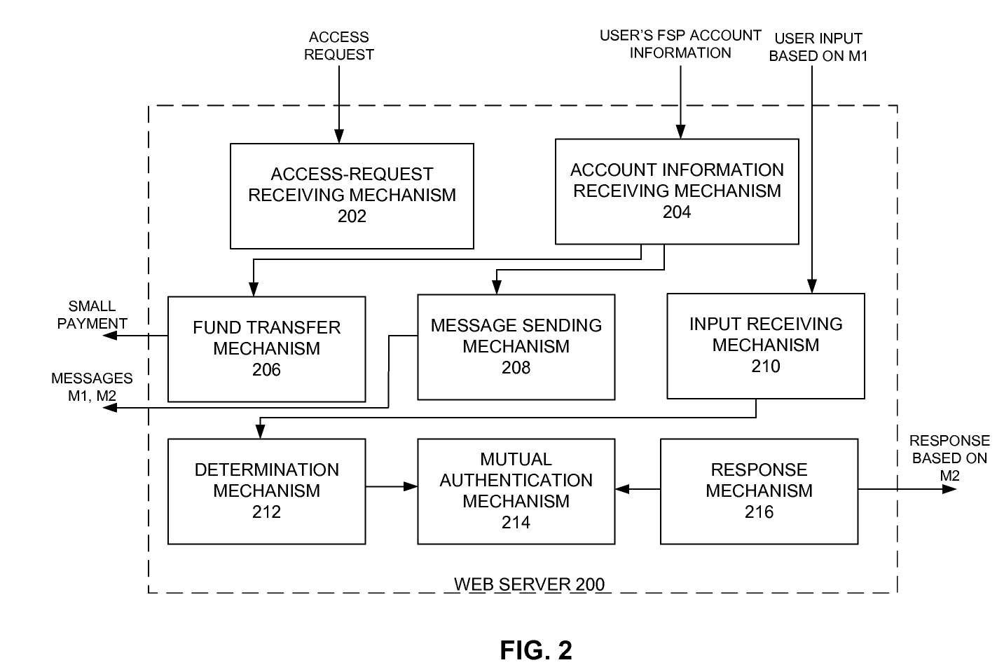

FIG. 2 illustrates a block diagram for a web server capable of mutual authentication in accordance with one embodiment of the present invention. Web server 200 includes an access-request receiving mechanism 202, an account information receiving mechanism 204, a fund transfer mechanism 206, a message sending mechanism 208, an input receiving mechanism 210, a determination mechanism 212, a response mechanism 216, and a mutual authentication mechanism 214.

During operation, access-request receiving mechanism 202 receives from a user a request for access to the online resource, or other authentication-based operation. Account information receiving mechanism 204 then requests and receives the financial-service account information from the user. In one embodiment, the financial-service account information can include a bank's identifier (such as the American Bankers Association (ABA) routing number) and an account number. Subsequently, fund transfer mechanism 206 transfers a small amount of fund to the user's account. For example, fund transfer mechanism 206 can transfer two cents to the requesting user's account. In some embodiments, the fun transfer mechanism 206 can transfer a fixed, small amount, such as one cent, to the user's account to minimize costs. In addition, since most financial services allow a message to be sent with a fund transfer, message sending mechanism 208 sends a message M along with the fund. In one embodiment, message M includes two portions, M1 and M2. As explained below, message M1 is used to authenticate the user to web server 200, and message M2 is used to authenticate web server 200 to the user. M1 and M2 can be randomly generated alphanumeric strings that are sufficiently robust against any dictionary attack. Note that these two portions, M1 and M2, can significantly increase the robustness of the system, because a malicious user might be able to guess the amount of the transferred fund. However, it would be much more difficult to guess the M1 and M2 messages.

Subsequently, web server 200 may request the user to input a response based on message M1. For example, the user may receive an email from web server 200 notifying the user to click on a link which leads to a web page that asks the user to input information based on message M1. Note that the user's response may be of various forms based on message M1. In one embodiment, the user may be requested to input the actual text of message M1. In further embodiment, the user may be requested to use M1 as a cryptographic key (such as an encryption key) to process contextual information. For example, the user can use M1 to encrypt the date of the transaction and send the encryption result as the input to web server 200.

In response, input receiving mechanism 210 receives the input from the user which is based on message M1. Determination mechanism 212 then determines whether the user input is consistent with the previously sent message M1. If the user input is consistent with M1, then the user is authenticated to web server 200. Note that if the user input is an encrypted message based on M1, determination mechanism 212 performs a similar encryption to the contextual information using its stored M1, and compares the user input with its own encryption result.

After determination mechanism 212 authenticates the user, response mechanism 216 within web server 200 sends a response to the user based on message M2. This response allows the user to authenticate web server 200, thereby facilitating mutual authentication. Similar to the user input, web server 200's response can also take various forms based on message M2. For example, it can be the text of message M2, or a message encrypted based on M2 as an encryption key. After the user authenticates web server 200 based on web server 200's response, mutual authentication mechanism generates a signal indicating that both the web server 200 and the user have been mutually authenticated.

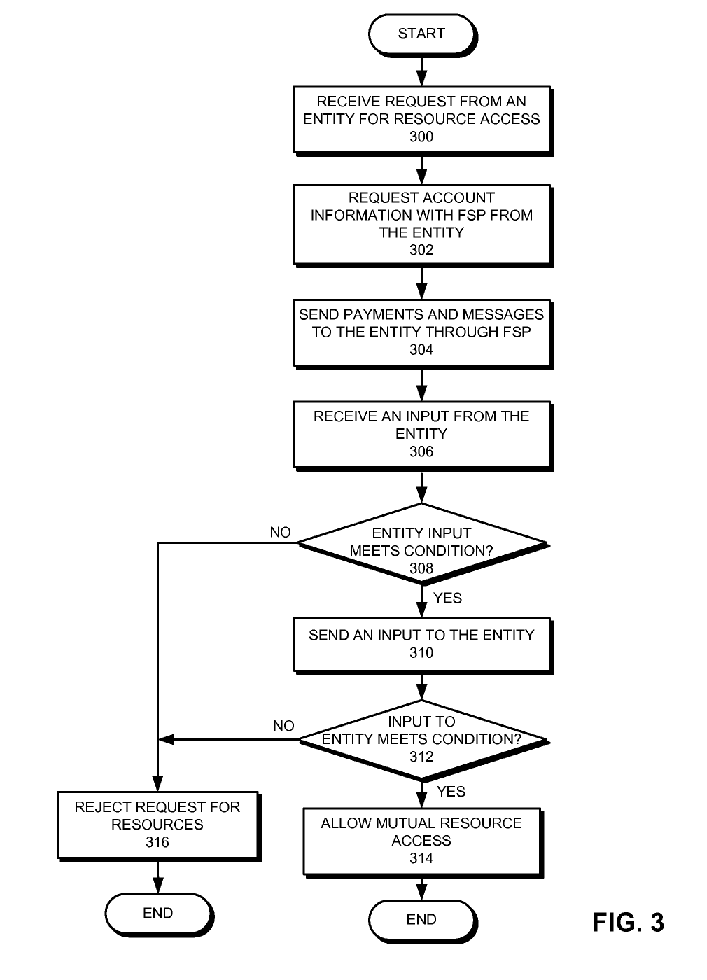

FIG. 3 presents a flowchart illustrating the process of mutual authentication between two entities (e.g., client 104 and web server 108) using small payments in accordance with one embodiment of the present invention. During operation, web server 108 receives a request from an entity for accessing the web server's resource (operation 300). The entity can be but is not limited to user 102 using client 104 or a proxy for user 102. In response, web server 108 requests the entity to provide information about an account from an FSP (operation 302). The account can be, but is not limited to: a bank account, a credit card account, a PayPal™ account, or a stock trade brokerage account.

After receiving the account information, the web server sends a small payment along with two messages M1 and M2, in the form of a memo or other type of user message, to the FSP account (operation 304). The server can send the payment using standard fund transferring techniques, such as wire transfer. In one embodiment, the server uses a proxy, such as the server's banking institution, to transfer the fund. The payment amount can be a randomly generated small number, such as a random number ranging from 1 cent to 99 cents. In one embodiment, the web server sends 1 cent in order to minimize cost. Both messages can be randomly generated alphanumeric strings to prevent a third party from predicting the messages. In one embodiment, at least one message includes an encryption key which can be used to generate an encrypted message of pre-agreed data, such as the date of the transaction.

Subsequent to receiving the payment on his FSP account along with the message, the user, or its proxy, sends an input to web server 108 (operation 306). The user can obtain the payment information and messages from FSP server 110. Alternatively, the FSP may notify the user of payment information and messages using other techniques, such as email. The user's input can include information about the amount of the payment and part one of the messages, M1. For example, the user's input may include a read back of message M1. In the case where message M1 includes an encryption key, the user's input includes an encrypted message based on commonly agreed information (such as date of the transaction) using the encryption key.

Web server 108 then determines whether the user's input meets certain conditions (operation 308). For example, web server 108 can determine whether the user-reported payment amount matches the amount sent by web server 108. Web server 108 can also determine whether the user correctly repeats the first message. In one embodiment, when an encryption key is used, web server 108 first decrypts the user's input using the same encryption key, and then determines if the decrypted message, such as the date of the transaction, matches a record on web server 108. In addition, the condition can be associated with a time interval, or can be associated with any policy in the context of environmental data acquired by the time the determination is made. By showing knowledge about the payment amount and the first message, the user proves to web server 108 his ownership of the FSP account. If web server 108 determines that the user's input does not meet the conditions, web server 108 rejects the user's request for access (operation 316).

If web server 108 determines that the user's input meets the conditions, web server 108 sends a response back to the user (operation 310). Such a response includes information based on message M2 previously sent by web server 108. For example, web server 108's input may include a read back of message M2. In the case where message M2 includes an encryption key, web server 108's input includes an encrypted message using the encryption key.

The user then determines whether web server 108's input meets certain conditions (operation 312). For example, the user can determine whether web server 108 correctly repeats the second message. When an encryption key is used, the user first decrypts the input and then determines whether the decrypt message, such as the date of the transaction, matches the user's record. By showing knowledge about message M2, web server 108 proves to the user that it is indeed the server that previously sent the messages with the fund transfer to the user. If the user determines that web server 108's input meets the conditions, mutual resource access between the user and web server 108 is allowed (operation 314). Otherwise, the user blocks web server 108 from accessing his resource (operation 316).

In one embodiment of the present invention, a centralized server can be used to approve mutual authentication between a client and a web server, or between two clients. In the embodiment, both the client and the web server authenticate themselves to the centralized server, which initiates the transfer of funds and messages.

Note that because it provides a level of security at least equal to that of a typical password, this mutual authentication mechanism can also facilitate password reset, which is another important problem faced by many web service providers.

To use this mutual authentication mechanism during password reset, a web server requests a user to input his FSP account information while setting up a service account. When the user later requests to reset the password of his service account, the web server sends a small payment along with a message to the user's FSP account. By showing his knowledge of the payment and the message, the user can authenticate himself to the server, thus gaining access to his service account. Alternatively, the web server can send a message, which includes a new password, to the user's FSP account along with a small payment. To avoid abusive password reset requests, which may be a result of practical jokes or part of a denial-of-service attack, the web server can keep the old password valid until the user has logged into the account using either password. Depending on the policy and his preference, a user can decide which password is the current password for the service account.

In addition to password reset, this authentication process can be used as a complement to the common OneID process, wherein the user's associated FSP can be the “home authentication center” for him.

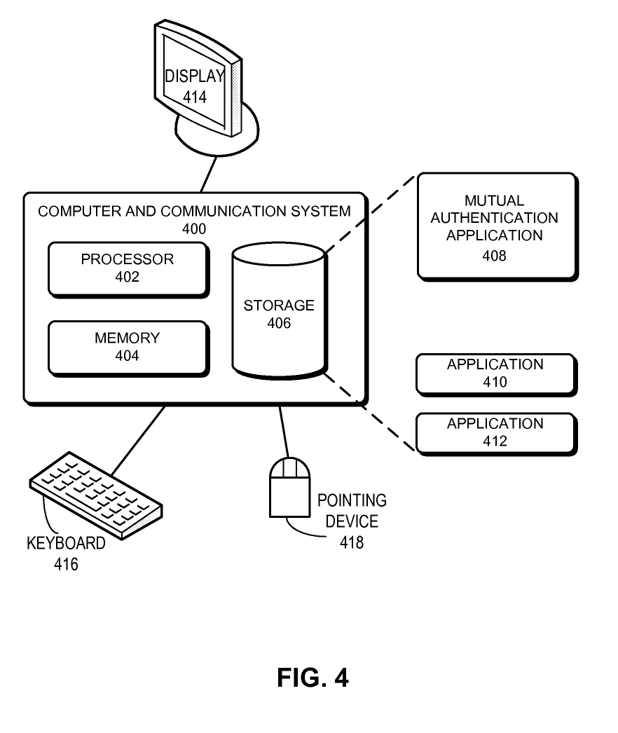

FIG. 4 illustrates an exemplary computer system for mutual authentication using small payments in accordance with one embodiment of the present invention. In one embodiment, a computer and communication system 400 includes a processor 402, a memory 404, and a storage device 406. Storage device 406 stores a mutual authentication application 408, as well as other applications, such as applications 410 and 412. During operation, mutual authentication application 408 is loaded from storage device 406 into memory 404 and then executed by processor 402. While executing the program, processor 402 performs the aforementioned functions. Computer and communication system 400 is coupled to an optional display 414, keyboard 416, and pointing device 418.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

The data structures and code described in this detailed description are typically stored on a computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

What is claimed is:

1. A computer-executed method for mutual authentication, the method comprising:
receiving a request at a first entity for resource access from a second entity;
requesting by the first entity information about the second entity's account with a financial service provider (FSP);
transferring a fund to the second entity's account;
sending a first message and a second message through the FSP to the second entity with the fund transfer;
receiving from the second entity a first input corresponding to the first message;
determining that a first condition is met based on the received first input and the first message;
sending a second input to the second entity based on the second message, thereby allowing the second entity to verify that a second condition is met based on the second input and the second message; and
producing a result indicating that both the first and second entities are mutually authenticated.

2. The method of claim 1, wherein the first and/or the second messages comprise randomly generated alphanumeric strings.

3. The method of claim 1, wherein the first message comprises an encryption key.

4. The method of claim 3, wherein the first input comprises a message encrypted with the encryption key.

5. The method of claim 1, wherein transferring the fund to the second entity's account is performed by a proxy.

6. The method of claim 1, further comprising receiving from the second entity a message identifying the amount of the transferred fund.

7. A computer-readable storage medium storing instructions which when executed by a computer cause the computer to perform a method for mutual authentication, the method comprising:
receiving a request at a first entity for resource access from a second entity;
requesting by the first entity information about the second entity's account with a financial service provider (FSP);
transferring a fund to the second entity's account;
sending a first message and a second message through the FSP to the second entity with the fund transfer;
receiving from the second entity a first input corresponding to the first message;
determining that a first condition is met based on the received first input and the first message;
sending a second input to the second entity based on the second message, thereby allowing the second entity to verify that a second condition is met based on the second input and the second message; and
producing a result indicating that both the first and second entities are mutually authenticated.

8. The computer-readable storage medium of claim 7, wherein the first and/or the second messages comprise randomly generated alphanumeric strings.

9. The computer-readable storage medium of claim 7, wherein the first message comprises an encryption key.

10. The computer-readable storage medium of claim 9, wherein the first input comprises a message encrypted with the encryption key.

11. The computer-readable storage medium of claim 7, wherein transferring the fund to the second entity's account is performed by a proxy.

12. The computer-readable storage medium of claim 7, wherein the method further comprises receiving from the second entity a message identifying the amount of the transferred fund.

13. A computer system for mutual authentication, comprising:
a processor;
a memory;
an access-request receiving mechanism configured to receive at a first entity a request from a second entity for access to a resource
an account-information receiving mechanism configured to receive at the first entity information about the second entity's account with a financial service provider;
a fund transfer mechanism configured to transfer a fund to the second entity's account;
a first sending mechanism configured to send a first message and a second message through the FSP to the second entity with the fund transfer;
an input receiving mechanism configured to receive from the second entity a first input corresponding to the first message;
a determination mechanism configured to determine that a first condition is met based on the received first input and the first message;
a second sending mechanism configured to send a second input to the second entity based on the second message, thereby allowing the second entity to verify that a second condition is met based on the second input and the second message; and
a mechanism configured to produce a result indicating that both the first and second entities are mutually authenticated.

14. The computer system of claim 13, wherein the first and/or second messages comprise randomly generated alphanumeric strings.

15. The computer system of claim 13, wherein the first message comprises an encryption key.

16. The computer system of claim 15, wherein the first input comprises a message encrypted with the encryption key.

17. The computer system of claim 13, further comprising a proxy configured to transfer the fund to the second entity's account.

18. The computer system of claim 13, wherein the second receiving mechanism is further configured to receive from the second entity a message identifying the amount of the transferred fund.
